(19) United States
(12) Patent Application Publication
(10) Pub. No.: US 2002/0042816 A1
(43) Pub. Date: Apr. 11, 2002

(54) Method and system for electronic mail service

(76) Inventor: Sang Geun Bae, Kumi-si (KR)

Correspondence Address: BIRCH STEWART KOLASCH & BIRCH, PO BOX 747, FALLS CHURCH, VA, 22040-0747, US

(21) Appl. No.: 09/971,232

(22) Filed: Oct. 5, 2001

(30) Foreign Application Priority Data
Oct. 7, 2000 (KR) 59031/2000

(51) Int. Cl. G06F 15/16

(52) U.S. Cl. 709/206

(57) ABSTRACT

The present invention relates to a method and system for an electronic mail service for transmitting an electronic mail with an automatic display of a state of a sender to an intended receiver. According to the present invention, the sender can select at least one degree of the state and register his or her state beforehand. Therefore, when the sender writes the electronic mail, his or her state is automatically displayed in the electronic mail form, thereby helping the receiver to properly react to the electronic mail from the sender by clearly understanding the present state of the sender at the time of writing the electronic mail.

### BACKGROUND OF THE INVENTION

1. Field of the Invention

The present invention relates to a method and system for an electronic mail service. In particular, the present invention relates to a method and system for transmitting electronic mails to the other party, and to a method and system for automatically displaying a state of a previously registered sender as the sender writes an electronic mail.

2. Description of the Related Art

In recent years, the remarkable development in computer related information telecommunication technologies has noticeably improved not only work efficiency but also daily lives of people. For example, more people are now using an on-line shopping mall on a network to purchase any commodities.

In addition, as an ultra-high speed network has become available to many within a very short period, a large number of households now enjoy a network having a data connection speed ranging several Mbit/sec. Accordingly, things that used to be impossible to do at home are now accomplished by using data from a multimedia with a high picture quality and high capacity over the Internet.

For an instance, an electronic mail that is transmitted through a network like the Internet, compared with other general mails and telephones, can send a message more rapidly and leave the message even when the other party (or the receiver) is not available. Moreover, people can send the electronic mail at any time and make sure the mail is sent properly. For the reasons aforementioned, much more people use the electronic mail to share their opinions with others. In fact, the electronic mail is already a part of life to most of people.

Despite of the advantages of the electronic mail, the telephone still has a few superior traits to the electronic mail. For example, when a person shares his or her opinion with the other party over the telephone, one easily perceives the other person's feeling or an emotional state. In other words, listening to the voice of each other, one can figure out how the other feels at present and understand his or her expression. Therefore, as one person tries to understand the other person's expression or opinion more correctly, both can eliminate any misunderstanding that might occur while conversing on the phone.

However, when a person uses the electronic mail to express his or her opinion to somebody, the receiver, without exactly knowing what the sender tries to say or how the sender feels, reads the message anyway. In such case, it is always possible that the receiver misunderstands the expression of the sender, raising an argument thereon.

### SUMMARY OF THE INVENTION

It is, therefore, an object of the present invention to provide a method and system for electronic mail service in which a sender transmits an electronic mail by selecting a present state of a receiver.

It is another object of the present invention to provide a method and system for automatically displaying a state of a sender by having the sender mark the state of the sender and register the same before he or she writes an electronic mail.

To achieve the above objects, there is provided a method and system for an electronic mail service, in which the electronic mail service receives a request of a sender to write an electronic mail; inserts at least one kind of a present state of the sender in an electronic mail form based on the request of the sender; provides the electronic mail form to the sender; receives the state of the sender based on the result the sender provided by selecting his or her state among a plurality of the states; and transmits the state of the sender to an electronic mail address written by the sender.

Another preferred embodiment of the present invention provides a method and system for an electronic mail service using an automatic display of a state of the sender, in which the electronic mail service receives a request of the sender to write an electronic mail; asks if a state of the sender is registered or not by using a sender identifier included in the request for writing the electronic mail; inserts the state of the sender corresponding to the sender identifier into an electronic mail form in case the sender has registered his or her state; and provides the sender with the electronic mail form that is supposed to be filled in by the sender.

Further to the above, the method and system for the electronic mail service with the automatic display of the state of the sender receives a request of the sender to register his or her state; provides a list with different degrees of a state corresponding to the register request of the sender; receives the result of the state provided by the sender based on his or her selection on the list; and registers the final state of the sender to be in correspondence with the sender identifier.

According to the method and system for the electronic mail service with the automatic display of the state of the sender, the state of the sender is renewed in response to a renewal request of the sender. Moreover, the state of the sender can be changed manually at the request of the sender to mark his or her state manually.

The state of the sender illustrated in the method and system for the electronic mail service with the automatic display of the state of the sender can be expressed, for example, how he or she feels at present, how busy he or she is at present, how healthy he or she is at present, or what kind of atmosphere he or she is in at present.

### BRIEF DESCRIPTION OF THE DRAWINGS

The above objects, features and advantages of the present invention will become more apparent from the following detailed description when taken in conjunction with the accompanying drawings, in which:

FIG. 1 is a schematic view of electronic mail system according to a preferred embodiment of the present invention;

FIG. 2 is a flow chart to explain a method for selecting a state of a sender by the sender in an electronic mail system according to a preferred embodiment of the present invention;

FIG. 3 is a schematic view of an electronic mail system according to another preferred embodiment of the present invention;

FIG. 4 is a flow chart to explain a method for registering a state of a sender beforehand by the sender in an electronic mail system according to another preferred embodiment of the present invention;

FIG. 5 is a flow chart to explain a method for automatically displaying a state of a sender registered previously by the sender when the sender writes an electronic mail in an electronic mail system according to another preferred embodiment of the present invention;

FIG. 6 is an exemplary view of a screen showing a feeling state of a sender in different degrees, the state being selected by the sender when he or she sends an electronic mail through an electronic mail system according to a preferred embodiment of the present invention; and

FIG. 7 is an exemplary view of a screen showing a state of a sender in different degrees showing that how busy the sender is at present, the state being selected by the sender when he or she sends an electronic mail through an electronic mail system according to a preferred embodiment of the present invention.

### DETAILED DESCRIPTION OF THE PREFERRED EMBODIMENT

A preferred embodiment of the present invention will now be described with reference to the accompanying drawings. In the following description, same drawing reference numerals are used for the same elements even in different drawings. The matters defined in the description are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

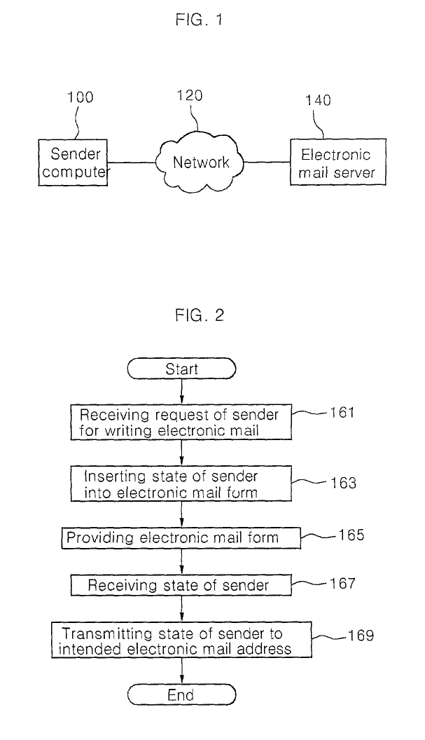

FIG. 1 is a schematic view of an electronic mail system according to a preferred embodiment of the present invention. As shown in FIG. 1, the system includes a sender computer 100 connected to a network 120 for making a request for an electronic mail service and an electronic mail server 140 for providing an electronic mail service corresponding to the request of the sender computer 100.

The sender computer 100 includes a network interface for connecting to the network 120, an exclusive line for transmitting data that have passed through the network interface to the network, and a browser for exchanging the data through the network. The sender using the sender computer 100 should know a URL address or an IP address of the electronic mail server 140 in advance. Therefore, the sender, using the URL address of the IP address, can go through the network 120 and connect to the electronic mail server 140 in order to receive the electronic mail service.

In case that the user connects and makes a request for the electronic mail service by using the sender computer 100, the electronic mail server 140 provides a data corresponding to the request. In order to meet such request, the electronic mail server 140 can save a variety of data concerning the electronic mail service beforehand. Especially, in response to the request of the sender to write the electronic mail, the electronic mail server 140 can save an electronic mail form on which the user can write his or his message.

In addition, the electronic mail server 140 has at least a data on a state of the sender in different degrees for the sender to be able to select.

The electronic mail server 140 can also save a program for providing the electronic mail service. The sender is provided with the result of his or her request of that was received and went through a processing through the program.

On the other hand, the electronic mail server 140 can be used for the electronic mail service only, or partially for a portal server with the electronic mail service. The sender, therefore, is provided with the electronic mail service by activating the program described above.

FIG. 2 is a flow chart to explain a method for selecting a state of a sender in an electronic mail system according to a preferred embodiment of the present invention. With reference to FIG. 2, in order to get the electronic mail service, the sender makes a request for writing an electronic mail (S161). Here, the sender is supposed to be a member before he or she makes the request for writing the electronic mail. In case that the sender actually applies for the membership, the electronic mail server 140 authenticates the sender, and creates a database to save the personal information of the sender. The member information can include a sender identifier the user requested.

Based on the request for writing the electronic mail, the electronic mail server confirms whether or not the sender is properly registered as a member. If the sender is a registered member, the electronic mail server claims an electronic mail form from a memory (not shown) and the degree of the state of the sender so that the sender can make a choice to clarify his or her state at present. Then, the data on the state of the sender is inserted to a designated place of the electronic mail form (S163). The correct position for inserting the degree of the state of the sender can be displayed through the program in advance. Accordingly, in case that the user claims the degree of the state of the user and the electronic mail form, the electronic mail server inserts the state of the sender, or the degree of the state of the sender, into the pre-designated place on the electronic mail form. At this time, the list with different degrees of the state of the sender can be provided to the sender in a form of an icon. For the purpose aforementioned, the electronic mail server generally saves an icon corresponding to the degree of the sender beforehand.

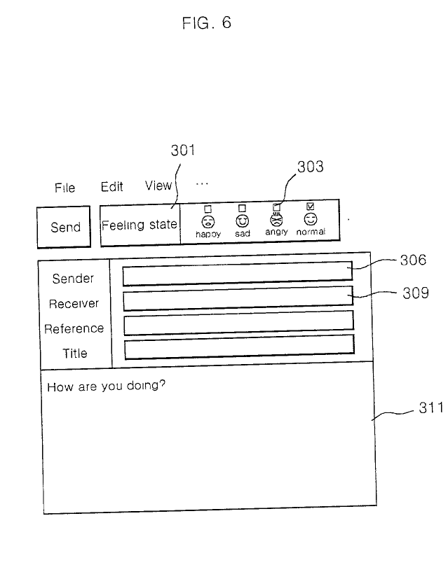

Later, the electronic mail form in which the degree of the state of the sender is inserted is provided to the sender (S165). Here, the degree of the state of the sender can be categorized into a feeling state at present, a busyness state at present, a health state at present, and an atmosphere state at present. Although only several kinds of the degree of the state of the sender is mentioned here, it should be remembered that a various kind of states can be included as long as they do not depart from the spirit and scope of the invention. As shown explicitly in FIG. 6, ‘the feeling state at present’ literally means how the sender feels at the moment.

FIG. 6 is an exemplary view of a screen showing the state of the sender, which the sender is supposed to select depending his or her feeling according to a preferred embodiment of the present invention.

With reference to FIG. 6, the screen includes an item for a feeling state 301, an electronic mail address window of a sender 306, an electronic mail address window of a receiver 309, and a window for entering content 311.

More specifically, the item for the feeling state 301 is again categorized into ‘happy’, ‘sad’ ‘angry’ and ‘normal’. The sender then selects one of the states through a selection window 303 provided. The electronic mail address of the sender is inputted to the electronic mail address window of the sender 306. Similarly, the electronic mail address of the other party is inputted to the electronic mail address window of the receiver 309. On the other hand, the message the sender wishes to send is inputted to the window for entering content 311.

Accordingly, the sender inputs or fills in all windows, such as, the electronic mail address window of the sender 306, the electronic mail address window of the receiver 309, and the window for entering content 311, marks the selection window 303 in accordance with his or her present feeling state by selecting one out of the items for a feeling state 301, selects a sending item to transmit the electronic mail to the intended address.

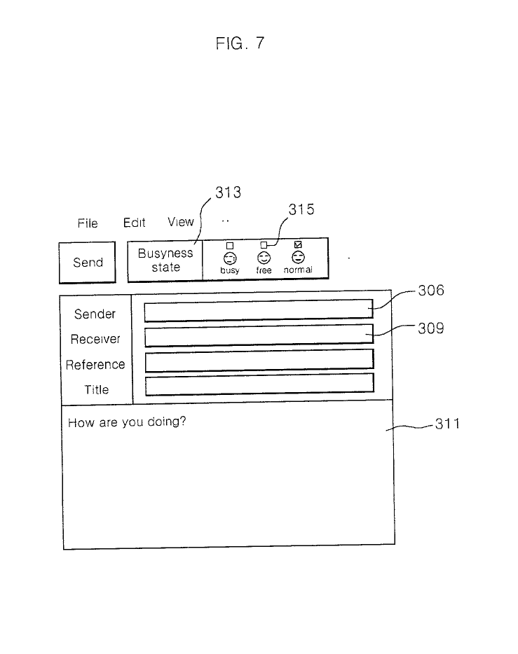

One of the states listed above, ‘the business state at present’ means how busy the sender at present as illustrated in FIG. 7.

FIG. 7 is an exemplary view of a screen showing the degree of the business state of the sender according to a preferred embodiment of the present invention.

As shown in FIG. 7, the screen includes an item for the business state 313, an electronic mail address window of the sender 306, an electronic mail address window of the receiver 309, and a window for entering content 311.

More specifically, the item for the business state 313 is again categorized into ‘very busy’, ‘free’, and ‘normal’. Accordingly, the sender inputs or fills in all windows, such as, the electronic mail address window of the sender 306, the electronic mail address window of the receiver 309, and the window for entering content 311, marks the selection window 303 in accordance with his or her present busyness state by selecting one out of the items for a feeling state 313, selects a sending item to transmit the electronic mail to the intended address.

Meanwhile, ‘the health state at present’ is asking how healthy the sender at present. More specifically, the health state can be categorized into ‘good’, ‘bad’, and ‘normal’.

Lastly, ‘the atmosphere state at present’ is asking for what kind of atmosphere the sender has while writing the electronic mail. More specifically, the atmosphere state can be categorized into ‘can write’, ‘can't write’, and ‘tolerable’.

The sender writes the electronic mail on the electronic mail form provided by the electronic mail server. Here, the sender should select at least one state of any categories that are included in the electronic mail form. Once the sender selects his or her state at present, the result is transmitted to the electronic mail server (S167). And, the electronic mail server transmits the electronic mail including the present state of the sender to the intended electronic mail address (S169). Moreover, the electronic mail server can save the electronic mail including the present state of the sender for a while. In such case, the receiver corresponding to the forwarding electronic mail address can check the message of the electronic mail from the sender by connecting to the electronic mail server.

FIG. 3 is a schematic view of the electronic mail system according to another preferred embodiment of the present invention. With reference to FIG. 3, the system is provided to automatically display the present state of the sender, which was previously registered by the sender as he or she wished to transmit the electronic mail. To achieve the object aforementioned, the electronic mail system includes a sender computer 200, a network 220, an electronic mail server 230, and an electronic mail management database 240.

Compared to FIG. 1, the system described above further includes the electronic mail management database 240 besides the sender computer 200, the network 220, and the electronic mail server 230. In other words, the system registers the state of the sender selected by the sender himself (or herself) to the electronic mail management database 240 corresponding to the sender identifier.

When the sender makes a request for writing the electronic mail form, the system automatically inserts the present state of the sender once the sender registers his or her state to the electronic mail form, and provides the form to the sender. At this time, the sender identifier is what the sender marked in case that he or she applied for the membership. Thus, the sender identifier is not necessarily identical with the one in the electronic mail address.

The electronic mail server 230 can save the present state of the sender to provide the result back to the sender. Here, the state of the sender is one of the feeling states at present, the busyness state at present, the health state at present, and the atmosphere state at present.

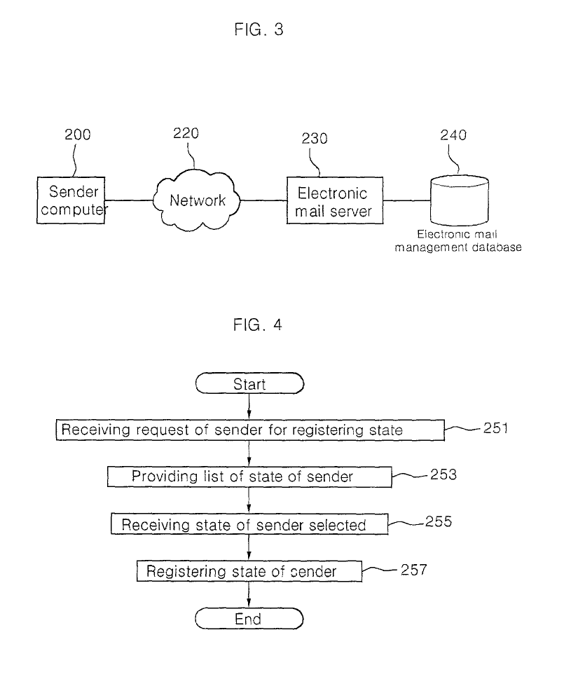

FIG. 4 is a flow chart to explain a method for having a sender register his or her state beforehand in an electronic mail system according to another preferred embodiment of the present invention.

With reference to FIG. 4, when the sender writes the electronic mail, the sender does not have to select his or her present state separately because the state has been already registered for the automatic display. In more detail, the electronic mail server first receives a request of the sender to pre-register his or her state (S251). Of course, the sender is supposed to be the registered member to be able to make the request. If the sender turns out to be the registered member, the sender can request for the registration of his or her present state by connecting to the electronic mail server via the network.

The electronic mail server then provides the sender with the list with different degrees of the state corresponding to the registration request of the sender (S253). The sender, using the degree of the state provided, selects one to show his or her present state, and transmits the result to the electronic mail server (S255). Later, the electronic mail server registers the state of the sender provided by the sender himself (or herself) to the electronic mail management database to be in correspondence to the sender identifier (S257). The reason the electronic mail server saves the state of the sender to be in correspondence to the sender identifier is that it can decide whether or not the sender has been already registered or not by using the sender identifier when the sender requests for writing the electronic mail later.

On the other hand, although it is not mentioned in FIG. 4, the state of the sender can be renewed per hour and day, depending on the state of the sender at that time of writing the electronic mail. That is, if the state of the sender is one of the feeling state, the busyness state, and the atmosphere state, the state of the sender can be renewed on an hourly basis. Meanwhile, if the state of the sender concerns his or her health state, the state can be renewed once a several days. However, it should be understood that renewing the state is a very personal thing to do, so it should be done only the sender feels it necessary to renew his or her state.

In addition, if the sender sometimes feels inconvenient to renew the state, he or she can ask the electronic mail server for a manual display for the state of the sender and mark the state manually. In such case, the method illustrated in FIG. 2 is used for the transmission of the electronic mail the sender wrote.

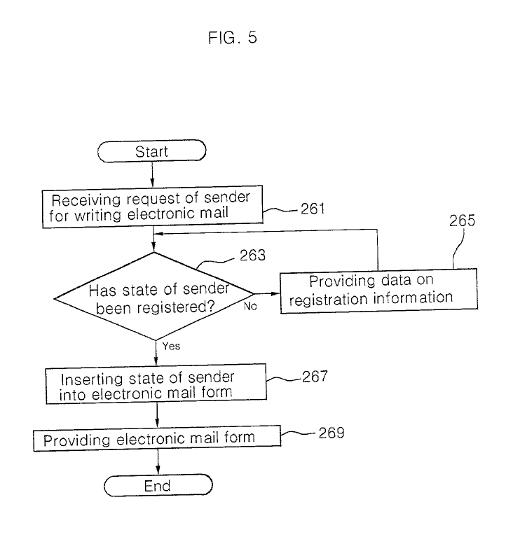

FIG. 5 is a flow chart to explain a method for making a state of a sender registered previously by the sender automatically displayed when the sender writes an electronic mail in an electronic mail system according to another preferred embodiment of the present invention. As shown in FIG. 5, the electronic mail server receives the request for writing the electronic mail from the sender (S261). Here, the request for registering the state of the sender can be accomplished through a login process. In such case, the request for registering the state of the sender can include a sender identifier.

Based on the sender identifier included in the request of the sender for registering the state of the sender, the electronic mail server inquires whether or not the state of the sender has been registered by using the electronic mail management database (S263). In result of the inquiry, if the sender has already registered his or her state to the electronic mail management database, the electronic mail server claims the state of the sender corresponding to the sender identifier from the electronic mail management database. Also, the electronic mail server claims an electronic mail form from the memory (not shown) and inserts the state of the sender (S267).

In case that the sender has not been registered his or her state in advance, the electronic mail server provides the sender with registration information to urge the sender to register his or her state (S265). In step 265, if the sender registers his or her state complying with the registration information provided by the electronic mail server, the next step 263 proceeds. The method for registering the state of the sender is well explained in FIG. 4.

Later, the sender receives his or her state inserted to the electronic mail form in step 267 (S269).

When the sender finishes writing in the electronic mail form, the message is duly transmitted to an intended receiver.

Therefore, the present invention makes it possible for the receiver to find out the state of the sender. In other words, the receiver can figure out the message from the sender taking the state of the sender into account, and understand better what the message tries to say.

According to the method and system for the electronic mail service of the present invention, the sender transmits the electronic mail including his or her present state, so the receiver who gets the electronic mail can confirm the state of the sender and figure out how to react to the message of the sender based on the state of the sender at the time of writing the electronic mail.

In addition, according to the method and system for the electronic mail service of the present invention, if the sender registers his or her state beforehand, the state is automatically displayed while the sender is writing the electronic mail. Thus, the sender does not have to mark his or her present state every time he or she writes the electronic mail.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for providing an electronic mail service in which an electronic mail written by a sender is sent to at least one receiver via a network, the method comprising the steps of:
receiving a request of the sender for writing the electronic mail;
recording at least one degree of a state of a sender into an electronic mail form based on the request of the sender, thereby helping the sender to select at least one state;
providing the electronic mail form to the sender;
receiving the status of the sender including at least one lever of the state selected by the sender; and
transmitting the state of the sender to an electronic mail address provided by the sender.

2. The method of claim 1, wherein the states of the sender are a current mood state, a current business state, a current health state and a current atmosphere state.

3. The method of claim 1, wherein at least one category of the state of the sender is displayed in an icon form.

4. A method for an electronic mail service for automatically displaying a state of a sender for an electronic mail application provided via a network, the method comprising the steps of:
receiving a request of the sender for writing the electronic mail;
inquiring whether or not the state of the sender has already been registered based on a sender identifier included in the request for writing the electronic mail;
inserting the state of the sender corresponding to the sender identifier into the electronic mail form in case that the user is a registered member; and
providing the sender with the electronic mail form for the sender to fill in the form and transmit the electronic mail to an intended receiver.

5. The method of claim 4, further comprising the steps of:
receiving a request of the sender for registering the state of the sender;
providing the sender with a degree of the state of the sender corresponding to the request for registering the state of the sender;
receiving the state of the sender selected by the sender based on the degree of the state of the sender; and
registering the state of the sender corresponding to the sender identifier.

6. The method of claim 4, wherein the state of the sender is renewed in response to a request of the sender for renewing the state.

7. The method of claim 4, wherein the state of the sender can be manually changed in response to a request of the sender for a manual display.

8. The method of claim 4, wherein the states of the sender are a current mood state, a current business state, a current health state and a current atmosphere state.

9. A system for an electronic mail including a memory with a program and a processor combined to the memory for carrying out the program, the system comprising the steps of:
receiving a request of a sender for writing an electronic mail;
inserting at least one degree of a state of the sender into an electronic mail form based on the request of the sender, thereby helping the sender to select at least one state;
providing the electronic mail form to the sender;
receiving the state of the sender that has been selected by the sender based on at least one degree of the state of the sender; and
transmitting the state of the sender to an electronic mail address provided by the sender.

10. A system for an electronic mail including an electronic mail management database, a memory with a program and a processor combined to the memory for carrying out the program, the system comprising the steps of;
receiving a request of the sender for writing an electronic mail;
inquiring whether or not the state of the sender has already been registered based on a sender identifier included in the request for writing the electronic mail;
inserting the state of the sender corresponding to the sender identifier into the electronic mail form in case that the user is a registered member; and
providing the sender with the electronic mail form for the sender to fill in the form and transmit the electronic mail to an intended receiver.

11. The system of claim 10, further comprising:
receiving a request of the sender for registering the state of the sender;
providing the sender with a degree of the state of the sender corresponding to the request for registering the state of the sender;
receiving the state of the sender selected by the sender based on the degree of the state of the sender; and
registering the state of the sender corresponding to the sender identifier.

12. A method for an electronic mail service, wherein an electronic mail comprises Information on a present state of a sender.

13. The method of claim 12, wherein the states of the sender are a current mood state, a current business state, a current health state and a current atmosphere state.

14. The method of claim 12, wherein the data on the present state of the sender is displayed in an icon form.
